(19) United States
(12) Patent Application Publication
(10) Pub. No.: US 2009/0323674 A1
(43) Pub. Date: Dec. 31, 2009

(54) METHOD FOR ESTABLISHING A TELEPHONE CONNECTION

(75) Inventor: Peter Wünsch, Herrsching (DE)

Correspondence Address: Schwabe Williamson & Wyatt;PACWEST CENTER, SUITE 1900, 1211 SW FIFTH AVENUE, PORTLAND, OR, 97204, US

(73) Assignee: GO YELLOW MEDIA AG, Munich (DE)

(21) Appl. No.: 12/297,031

(22) PCT Filed: Mar. 8, 2007
(86) PCT No.: PCT/EP07/02026

§ 371 Date: Apr. 14, 2009

(30) Foreign Application Priority Data
Apr. 11, 2006 (DE) 10 2006 017 050.4

(51) Int. Cl. H04L 12/66

(52) U.S. Cl. 370/352

(57) ABSTRACT

The invention relates to a method for establishing a telephone connection between a caller and a party to be called via a service provider. According to said method, the caller establishes an Internet connection to the service provider with the aid of a data processing unit and transmits information identifying both the caller and the party to be called to the service provider via the Internet connection. In response, the service provider makes available a transmission path for the telephone connection, by analysing at least the information identifying either the caller or the party to be called in accordance with a predefined criterion and by transmitting selected information, depending on the analysis result, to at least one of the parties via the Internet connection and/or the transmission path.

The present invention relates to a method for establishing a telephone connection between a caller and a party to-be-called via a service provider. According to said method, the caller establishes an internet connection to the service provider with the aid of a data processing unit and transmits information identifying both the caller and the party to-be-called to the service provider via the internet connection. In response, the service provider makes available a transmission path for the telephone connection.

Such methods, for example, are used to reduce cost when replacing a line switch for establishing a phone connection using conventional circuit-switching technology with a packet switch for establishing a packet-switched telephone connection. Circuit-switching technology is used in traditional telephone connections, such as analog telephone connections or “ISDN” telephone connections. These connections are synchronous, i.e. information transmission from one section of the line to a subsequent section takes place essentially without time delay. This creates a continuous connection in real time with the full bandwidth of a channel between two points available, even if no Nutznachrichten are sent. Therefore, the transmission channel is engaged during the entire duration of the telephone conversation. Accordingly, circuit-switched connections are expensive because of the cost regardless of the information that is actually transferred.

When packet-switching technology is used the data of the information to be transmitted during the call are packaged and transmitted as data packets. Packet switching works in an asynchronous transfer mode, i.e. information is transferred time delayed between two adjacent sections with the help of appropriate packet switching equipment. In packet switching, unlike in line switching, it is not necessary to maintain a firm connection. Each package is treated individually and not in connection with other packages. Packet switching is especially used on the internet. Here, the data packets are referred to as IP packets (IP=internet protocol). Accordingly, methods for conducting telephone calls using packet-switching technology are referred to as VoIP (Voice over Internet Protocol). Such calls can be carried out cost-effectively using the internet. However, both, the receiver as well as the transmitter are required to have packet switching equipment that on one side converts acoustic information in the appropriate data blocks and on the other side reconstructs the original acoustic information from these data blocks. Such equipment is usually not available to internet users. For this reason, in so-called internet telephony one may resort to methods described above.

In these methods, the service provider provides packet switching systems where the acoustic information, possibly through a line for local calls, reaches the service provider as a circuit-switched call and on the receiver side is also transferred in circuit-switched mode in the local network between a suitable transformer station and the receiver telephone or the party to-be-called. Overall, the cost for long distance calls can be significantly reduced, because only charges for circuit-switched local calls, but not for circuit-switched transfers between individual local networks are incurred. This transfer between individual local networks takes place much more cost-effective over the internet by using packet switching technology. The above-mentioned circuit and packet switching technologies, are described, for example, in EP 0 929 884 B1. The disclosure of this patent with respect to circuit and packet technologies and interfaces between these technologies is explicitly included in this description. In the method described above the information required by the service provider for establishing the telephone connection is also provided cost-effectively over the internet. Overall, therefore, in connection with conducting telephone calls, only fees for local calls are incurred, provided the required networking is available. The service provider has to charge these fees to the service user, which incurs additional costs.

The present invention is based on the task to provide additional use for the information used to establish a telephone connection, which allows for a cost reduction for the service user and reduces the administrative burden on the service provider.

According to the present invention, this technical problem is solved by an extension of known methods, essentially characterized by the service provider analyzing identifying information of at least one of the caller or the party to-be-called according to a preset criterion and transmits, depending on the analysis result, selected information via an internet connection and/or transmission path to at least one of the two parties.

According to the present invention, the information necessary to establish the telephone connection is used to select additional service user specific information and to make this information available to the service users. This additional information may include, for example, advertising information, which may be geared exactly towards the service user following analysis of information needed for establishing the telephone connection. Therefore, in connection with the forwarding of selected information by the providers of the selected information, such as advertisers, higher fees may be charged in connection with the transfer of this information to the service user. These higher fees can in turn cover the telephone tariffs which on one hand provides relief to the service users (caller and party to-be-called) and on the other reduces the administrative burden of the service provider as individual bills for the service users are no longer necessary. Rather, it suffices to offset the charges incurred by the company providing the selected information with the telephone fees. Overall, therefore, the above task is solved with the help of the according to the present invention proposed additional use of the information for establishing of a telephone connection.

As described above, according to the method provided by the present invention, the transmission path may be provided, at least in sections, such as between the caller and the service provider, through a circuit switch with circuit switching technology, for example through a conventional telephone connection by using a so-called “TK system”. Obviously, according to the method provided by the present invention, the transmission path may be provided, also at least in sections, such as between the service provider and the party to-be-called or a packet switching technology provider attributable to the party to-be-called by using a packet switching technology. Hereby, the conventional VoIP, for example, using the usual “Session Initiation Protocol” (SIP), may be used.

Usually the transmission path provided by the service provider includes at least one circuit-switched section and at least one packet-switched section. In this case, signals of the information content transmitted through the transmission path and transferred between the parties pass at least one signal converter system to convert signals transmitted by a circuit switching technology to signals in a packet switching technology communicable signals and/or a further signal converter system to convert the signals transmitted by packet switching technology to signals transmittable by circuit switching technology.

In a particularly preferred embodiment of the present invention, on the basis of the analysis result selected information is transmitted through an internet connection to a data processing system used by the caller to contact the service provider and is shown on an appropriate display of the data processing unit. This accomplishes, that the telephone connection is not disturbed by the selected information. However, in this case the intended use of selected information can not be ensured.

For this reason, a particularly preferred embodiment of the present invention provides that the transmission path for the telephone connection between the caller and the party to-be-called will be automatically disconnected once the internet connection is interrupted which certainly would prevent the intended use of selected information.

Within the scope of the present invention it has proved to be particularly useful if the information identifying the caller and/or the party to-be-called includes a telephone number. Such a telephone number is not only usable to establish the desired telephone connection. It also allows at least through review or analysis of the area code of the caller and/or the party to-be-called to narrow down the geographical location of the caller and/or the party to-be-called, and this location information may be used for the selection of the information to be transmitted through the internet and/or the transmission path. For example, for advertisement of a specific product with the help of selected information, by using the area code included in the phone number a local supplier of corresponding products may also be mentioned and included in the advertisement.

To increase the accuracy in determining the geographic location of the caller and/or the party to-be-called further, an address of the caller and/or the party to-be-called derived through “reverse lookup” and hence the exact geographical origin or the exact geographical target of the call may be determined. Using “reverse look-up ”, calls to merchants and/or companies may provide also information regarding the industry of the party to-be-called and the information to be transmitted through the internet connection and/or transmission path may be selected accordingly. Such a selection is particularly easy, when the identifying information of the party to-be-called may be selected from a directory of the service provider accessible by the caller through the internet connection, for example, by clicking on a window or screen section assigned to the party to-be-called. The use of the telephone service to be offered by the service provider can be simplified if identifying information of the data processing system of the caller, such as a “cookie” of the service provider left in the data processing unit in a previous session is automatically transmitted to the service provider when establishing the internet connection and the caller identifying information is provided automatically on the basis of this data processing unit identifying information.

Especially in those cases where the selected information applies to advertising, it has proved its worth when the selected information is provided by an AD-server of the service provider and/or a service provider associated AD server. Hereby, the selected information may be provided by a “streaming” method, especially as “flash”. “Streaming” is the continuous transmission of data, i.e. the transfer of data streams.

As already mentioned above, the selected information may be determined on the basis of the geographical location of the caller and/or the party to-be-called. Hereby, the geographical location may be determined based on a telephone number of the caller and/or the party to-be-called, an IP address of the party establishing the internet connection and/or information from the directory of the service provider. In addition to the caller and/or party to-be-called identifying information, the information to be transmitted to at least one of the two parties may be determined taking into account the time, date and/or environmental parameters, such as the temperature at the location of the caller and/or the party to-be-called. It is conceivable, for example, that vendor-specific advertisement is determined taking into account the time and temperature at the location of the caller.

In a particularly preferred embodiment of the present invention, the selected information consists of two, three or more chronologically transmitted information blocks with a distinctive content, where appropriate, the timing of the transmission of the information blocks is provided on the basis of the information content of the information blocks of the caller identifying information and/or the party to-be-called identifying information. This way, for example, the succession of commercials by competitors may be prevented and/or a product series, which is relevant to the caller and/or the party to-be-called according to the available information, may be promoted through a preset sequence of information blocks.

Methods according to the present invention may be applied, in particular in the case of advertising-financed, web-based calling. This application only makes sense if the selected information is noted by the caller and/or the party to-be-called. That can not be expected, for example, if certain types of connections are activated only for short periods of time. For this reason, within the scope of the present invention, it has proved to be particularly sensible when telephone connection patterns are analyzed according to preset criteria and the telephone connection is denied then, when the analysis of previous patterns of the same connection shows an abuse, for example, if bogus calls or a “click fraud” are detected.

The realization of methods according to the present invention can be described as follows:

A caller interested in establishing a telephone connection establishes an internet connection with the service provider. Through this internet connection, possible parties to-be-called, e.g. merchants, appear on the screen of data processing system of the caller. By mouse-click, the caller may select a party to-be-called from the presented directory. The party to-be-called identifying information, possibly including a telephone number, are available to the service provider and are used to establish the telephone connection. Afterwards, the caller is prompted by the internet connection to forward information identifying him to the service provider via the internet connection. The service provider then establishes individual telephone connections to the caller and the party to-be-called, which subsequently are connected by the service provider to establish a direct connection between the caller and the party to-be-called. This telephone connection provided by the service provider may include a section with packet switching technology that is connected on the side of the caller and/or the party to-be-called with a circuit-switched section.

During the telephone conversation, the service provider is monitoring, whether the internet connection used to pass on required information to establish the phone connection is maintained. Once it is determined that such internet connection, that may transmit advertising content to the caller, is interrupted, the phone connection is also interrupted. The Internet service provider may leave a “cookie” in the data storage system of the caller via the internet connection. If this data processing unit is again used later to establish an internet connection with the service provider, this “cookie” may be transferred to the service provider and may be used to load automatically information identifying the caller, such as the telephone number of the caller. Services offered by the method of the present invention can also be provided through so-called “internet portals”. It is also thought to analyze the “electronic traces” generated by the caller and/or the party to-be-called when using the methods of the present invention and to use them for other services. Based on the evaluation of the “electronic trail”, for example, commercials may be placed independently of telephone calls.

Above, methods of the present invention were described using embodiments in which the selected information is transmitted via an internet connection to the caller. Additionally, or alternatively, the selected information may be transmitted over the telephone connection itself to the caller and/or party to-be-called.

1. Method for establishing a telephone connection between a caller and a party to-be-called via a service provider in which the caller establishes an internet connection to the service provider with the aid of a data processing unit and transmits information identifying both the caller and the party to-be-called to the service provider via the internet connection and, the service provider then makes available a transmission path for the phone connection, characterized by the service provider analyzing at least one of the caller or the party to-be-called identifying information according to a preset criterion and transmits selected information that depends on the result of the analysis via the internet connection and/or the transmission path to at least one of the two parties.

2. A method according to claim 1, characterized by the transmission path being provided at least in some sections by a circuit switch with a circuit switching technology.

3. A method according to claim 1, characterized by the transmission path at least in some sections being provided by a packet switching system with a packet switching technology.

4. A method according to claim 1, characterized by signals representing information transmitted via the transmission path and to be exchanged between the parties passing at least one signal converter system to convert signals transmittable by circuit switching technology in signals transmittable by a packet switching technology and/or vice versa.

5. A method according to claim 1, characterized by automatically interrupting the transmission path once the internet connection is interrupted.

6. A method according to claim 1, characterized by information identifying the caller and/or the party to-be-called including a phone number.

7. A method according to claim 1, characterized by information identifying the party to-be-called being selected by the caller from a service provider's directory that is accessible via an internet connection.

8. A method according to claim 1, characterized by automatically transmitting information identifying the data processing unit of the caller to the service provider when establishing the internet connection and automatically providing information identifying the caller based on this information.

9. A method according to claim 1, characterized by providing the selected information by an AD server of the service provider and/or an AD server associated with the service provider.

10. A method according to claim 1, characterized by providing the selected information by a “streaming” method, especially as “flash” (“Macromedia Flash”).

11. A method according to claim 1, characterized by determining the selected information based on information representing the geographical location of the caller and/or the party to-be-called.

12. A method according to claim 1, characterized by determining the geographical location based on a telephone number of the caller and/or the party to-be-called, an IP address of the party establishing the internet connection and/or information from the directory of the service provider.

13. A method according to claim 1, characterized by determining the selected information taking into account the time, date and/or environmental parameters, such as the temperature at the location of the caller and/or the party to-be-called.

14. A method according to claim 1, characterized by the selected information consisting of two, three or more chronologically transmitted information blocks.

15. A method according to claim 14, characterized by specifying the chronological order of the transfer of information blocks on the basis of the information content of the information blocks, the information identifying the caller and/or the information identifying the party to-be-called.

16. A method according to claim 14, characterized by analyzing telephone connection pattern according to preset criteria and by denying to establish a telephone connection if the analysis of previous patterns of the same connection shows an abuse.
